(19) United States
(12) Patent Application Publication
(10) Pub. No.: US 2025/0259450 A1
(43) Pub. Date: Aug. 14, 2025

(54) SYSTEM AND METHODS FOR MONITORING FACILITY POPULATION AND ACTIVITY

(71) Applicant: Musco Corporation, Oskaloosa, IA (US)

(72) Inventors: Andrew J. Schembs, Johnston, IA (US); Alireza Razavi, West Des Moines, IA (US); Jansel Emmanuel Herrera-Gerena, Ankeny, IA (US)

(21) Appl. No.: 19/048,204

(22) Filed: Feb. 7, 2025

Related U.S. Application Data
(60) Provisional application No. 63/551,950, filed on Feb. 9, 2024.

(51) Int. Cl. G06V 20/52; G06V 20/40; G06V 40/16; G07C 9/30; H04N 7/18

(52) U.S. Cl. CPC G06V 20/52; G06V 20/41; G06V 40/161; G06V 40/172; G07C 9/30; H04N 7/181

(57) ABSTRACT

The disclosure describes systems and methods for monitoring activity at a facility. A device controls each of one or more cameras to capture a respective video stream of a respective area. For a first area in a first video stream captured by a first camera of the one or more cameras, the device defines an entry boundary in the first area on the first video stream, detects, within the first video stream, a person crossing from a first side of the entry boundary to a second side of the entry boundary, and updates a counter based on the person crossing from the first side of the entry boundary to the second side of the entry boundary.

### RELATED APPLICATIONS

This application claims the benefit of U.S. Provisional Application No. 63/551,950, filed Feb. 9, 2024, the entire contents of which are incorporated herein by reference.

### TECHNICAL FIELD

The disclosure relates to cameras and facility monitoring techniques.

### BACKGROUND OF THE INVENTION

Venues of almost any size or location (e.g., indoors or outdoors) have population limits that are a matter of public safety. Exceeding those population limits at any given time can be dangerous to both person and property. Most venues use tickets or doormen at particular entry points to keep track of the current population at any given time to ensure that these limits are not exceeded. However, this can be impossible at certain venues where there are multiple entry or exit points, or where the event is free and tickets are not required.

### SUMMARY OF THE INVENTION

In general, the disclosure describes systems and methods for monitoring activity at a facility. A device controls each of one or more cameras to capture a respective video stream of a respective area. For a first area in a first video stream captured by a first camera of the one or more cameras, the device defines an entry boundary in the first area on the first video stream, detects, within the first video stream, a person crossing from a first side of the entry boundary to a second side of the entry boundary, and updates a counter based on the person crossing from the first side of the entry boundary to the second side of the entry boundary.

In many venues that do not require tickets, it may be impossible to track how many individuals are at the venue at any given time. By utilizing the techniques described herein, venues can ensure that population limits are followed by digitally tracking the comings and goings of individuals at a venue, especially venues with multiple entry and exit locations. The techniques can be expanded to monitoring a number of unique individuals that visit a venue throughout a time period, keeping track of total visitors throughout a time period, or even detecting dangerous or anomalous events.

In one example, the disclosure is directed to a method in which a computing device controls each of one or more cameras to capture a respective video stream of a respective area. For a first area in a first video stream captured by a first camera of the one or more cameras, the computing device defines an entry boundary in the first area on the first video stream. The computing device detects, within the first video stream, a person crossing from a first side of the entry boundary to a second side of the entry boundary. The computing device may update a counter based on the person crossing from the first side of the entry boundary to the second side of the entry boundary.

In another example, the disclosure is directed to a system including one or more cameras and one or more processors configured to control each of the one or more cameras to capture a respective video stream of a respective area. The one or more processors are further configured to, for a first area in a first video stream captured by a first camera of the one or more cameras, define an entry boundary in the first area on the first video stream, detect, within the first video stream, a person crossing from a first side of the entry boundary to a second side of the entry boundary, and update a counter based on the person crossing from the first side of the entry boundary to the second side of the entry boundary.

In another example, the disclosure is directed to a non-transitory computer-readable storage medium containing instructions. The instructions, when executed, cause one or more processors to control each of one or more cameras to capture a respective video stream of a respective area. The instructions, when executed, further cause the one or more processors to, for a first area in a first video stream captured by a first camera of the one or more cameras, define an entry boundary in the first area on the first video stream, detect, within the first video stream, a person crossing from a first side of the entry boundary to a second side of the entry boundary, and update a counter based on the person crossing from the first side of the entry boundary to the second side of the entry boundary.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating a venue with a camera system and computing device configured to monitor population and activity, in accordance with the techniques described herein.

FIG. 2 is a block diagram illustrating a more detailed example of a computing device configured to perform the techniques described herein.

FIG. 3 is a conceptual diagram illustrating a venue with two different boundaries defined by the camera system and computing device to monitor population and activity, in accordance with the techniques described herein.

FIG. 4 is a conceptual diagram illustrating a camera system and computing device configured to monitor population and activity on a piece of playground equipment, in accordance with the techniques described herein.

FIG. 5 is a flow diagram illustrating an example method for monitoring population and activity at a venue, in accordance with the techniques described herein.

FIG. 6 is an image illustrating an aerial view of an area of interest monitored by multiple cameras, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

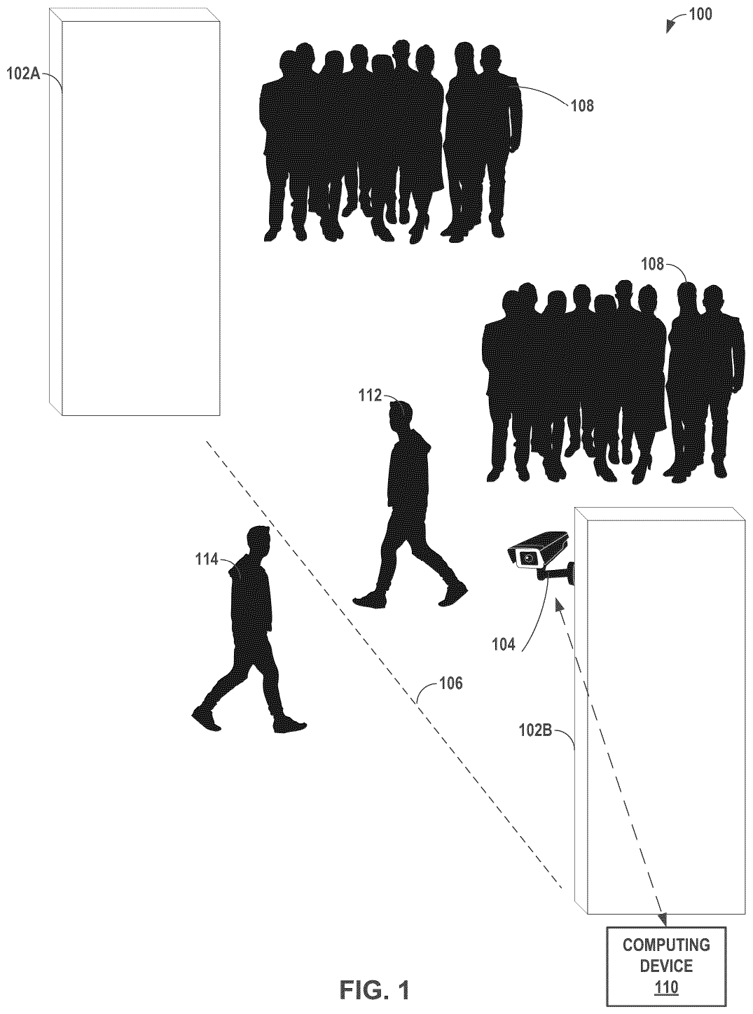

FIG. 1 is a conceptual diagram illustrating a venue 100 with a camera system 104 and computing device 110 configured to monitor population and activity, in accordance with the techniques described herein. Venue 100, or area 100, may be any indoor or outdoor facility that receives people to attend any of a number of events, including sports games, music performances, artistic displays, markets, playgrounds, or any other gathering of people where it may be important to monitor behavior and/or population counts.

Camera 104 may be any video camera capable of capturing a video stream of venue 100 and communicating that video stream to computing device 110. In the example of FIG. 1, only a single camera 104 is shown. However, in other examples, additional cameras may be present, either monitoring the same area (e.g., camera 104 s installed on pillar 102B, and an additional camera could be installed on pillar 102A) or at a different location monitoring a different area at venue 100 (e.g., a second camera could be in communication with computing device 110 and monitoring another entry/exit point). Any number of cameras can be installed at venue 100 to monitor different areas, each camera in communication with venue 100, enabling computing device 110 to monitor the population and activity throughout the venue regardless of where people enter or exit venue 100.

Crowd 108 may consist of a certain number of people that are present at the venue. Person 112 may be someone exiting venue 100, while person 114 may be entering venue 100.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

In accordance with the techniques of this disclosure, computing device 110 may control each of one or more cameras 104 to capture a respective video stream of a respective area. For a first area 100 in a first video stream captured by a first camera of the one or more cameras, computing device 110 may define entry boundary 106 in first area 100 on the first video stream. Computing device 110 may detect, within the first video stream, a person 114 crossing from a first side of entry boundary 106 to a second side of entry boundary 106. Computing device 110 may update a counter based on person 114 crossing from the first side of entry boundary 106 to the second side of entry boundary 106. Similarly, in some examples, computing device 110 may detect person 112 crossing from the second side of entry boundary 106 to the first side of entry boundary 106, and may similarly update the counter based on this crossing.

In other words, computing device 110 may store any number of counters that track a number of statistics, such as current population, total visitors over a particular time period, unique visitors over a particular time period, or a number of entries and exits from the venue, among other things. Depending on the particular goal of the counter, computing device 110 may update the counter accordingly based on the crossings. For instance, for a current population counter, computing device 110 may increase the counter when person 114 crosses entry boundary 106, and may decrease the counter when person 112 crosses entry boundary 106. For a total population counter, computing device 110 may increase the counter when person 114 crosses entry boundary 106, and may refrain from altering the counter when person 112 crosses entry boundary 106. For a total unique population counter, computing device 110 may increase the counter when person 114 crosses entry boundary 106 if person 114 has been determined to have not visited venue 100 before, may refrain from increasing the counter when person 114 is making a return trip to venue 100, and may refrain from altering the counter when person 112 crosses entry boundary 106. For a total number of entries and/or exits, computing device 110 may increase the counter when person 114 crosses entry boundary 106, and may increase the counter when person 112 crosses entry boundary 106.

In many venues, particularly those that do not require tickets or have multiple entry and exit points, monitoring the population and ensuring safety compliance can present a significant challenge. Traditional methods, such as employing doormen or using ticket systems, often prove inadequate in these settings. These methods rely heavily on manual counting and monitoring, which can be prone to human error and inefficiencies. Furthermore, in large or open venues, tracking the number of individuals present at any given time is difficult, leading to potential safety hazards if population limits are exceeded.

Existing solutions in the field of facility monitoring often involve static surveillance systems that provide limited functionality beyond basic video recording. These systems typically lack the capability to dynamically track and analyze the movement of individuals within a venue. As a result, they do not offer real-time insights into population density or the ability to respond promptly to changes in crowd size. Additionally, many current systems do not integrate advanced analytics to differentiate between distinct individuals or to detect specific activities, which limits their effectiveness in managing venue safety and operations.

The present system and method address these challenges by introducing a way to monitor facility population and activity using advanced camera and processing technologies. The approach leverages one or more cameras to capture video streams of designated areas within a venue. A computing device processes these video streams to define entry and exit boundaries, detect individuals crossing these boundaries, and update counters that reflect the current population and other relevant statistics. This system provides a comprehensive solution for real-time monitoring and management of venue populations, ensuring compliance with safety regulations and enhancing operational efficiency. By utilizing sophisticated analytics, the system can also track individual visitors, monitor specific activities, and detect anomalous events, offering a robust tool for venue management.

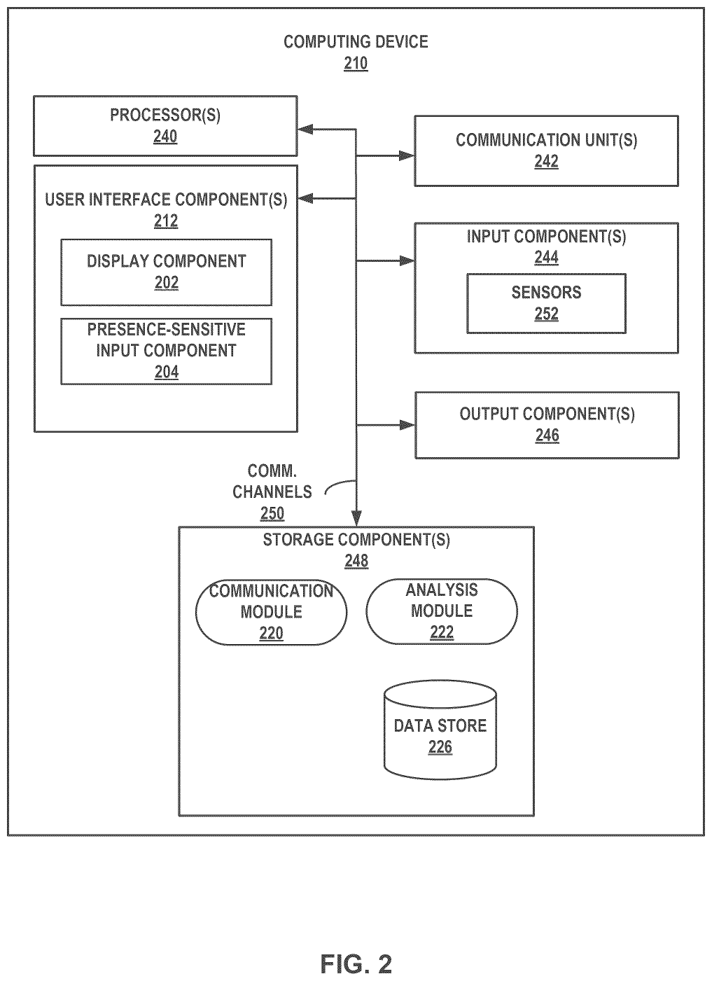

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to monitor venue population and activity. That is, processors 240 may implement functionality and/or execute instructions associated with computing device 210 to track the comings and goings of spectators at a venue.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to monitor venue population and activity.

Communication module 220 may execute locally (e.g., at processors 240) to provide functions associated with controlling cameras and receiving video streams from those cameras. In some examples, communication module 220 may act as an interface to a remote service accessible to computing device 210. For example, communication module 220 may be an interface or application programming interface (API) to a remote server that controls cameras and receives video streams from those cameras.

In some examples, analysis module 222 may execute locally (e.g., at processors 240) to provide functions associated with analyzing the video streams to track populations and activity. In some examples, analysis module 222 may act as an interface to a remote service accessible to computing device 210. For example, analysis module 222 may be an interface or application programming interface (API) to a remote server that analyzes the video streams received from the cameras. In still other examples, analysis module 222 may be split between a local module and a remote server, where analysis module 222 processes the video streams locally and pushes the raw results of that analysis and the video stream to the remote server for final processing and output generation.

One or more storage components 248 within computing device 210 may store information for processing during operation of computing device 210 (e.g., computing device 210 may store data accessed by modules 220 and 222 during execution at computing device 210), including any of the counters described herein. In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input.

Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may control each of one or more cameras to capture a respective video stream of a respective area. For a first area in a first video stream captured by a first camera of the one or more cameras, analysis module 222 may define an entry boundary in the first area on the first video stream. Analysis module 222 may detect, within the first video stream, a person crossing from a first side of the entry boundary to a second side of the entry boundary. Analysis module 222 may update a counter based on the person crossing from the first side of the entry boundary to the second side of the entry boundary.

In some instances, analysis module 222 may define an exit area as being on the first side of the entry boundary and may define an entry area as being on the second side of the entry boundary. In such instances, analysis module 222 may update the counter by increasing the counter based on the person crossing from the exit area to the entry area.

In other instances, analysis module 222 may define an entry area as being on the first side of the entry boundary and may define an exit area as being on the second side of the entry boundary. In such instances, analysis module 222 may update the counter by decreasing the counter based on the person crossing from the exit area to the entry area.

In still other instances, analysis module 222 may define an exit boundary in the first area on the first video stream. In such instances, analysis module 222 may detect, within the first video stream, the person crossing from a first side of the exit boundary to a second side of the exit boundary. In some such instances, the counter may be a current population counter, and analysis module 222 may update the counter based on the person crossing from the first side of the exit boundary to the second side of the exit boundary. In other such instances, the counter may be a total population counter, and analysis module 222 may refrain from updating the counter based on the person crossing from the first side of the exit boundary to the second side of the exit boundary. The exit boundary may be a same boundary as the entry boundary, or may be distinct from the entry boundary, wherein the exit boundary is on the first side of the entry boundary, and wherein the entry boundary is on the first side of the exit boundary.

In some instances, analysis module 222 may determine one or more characteristics of the person. The characteristics may be apparel worn by the person, hair color of the person, hair length of the person, height of the person, weight of the person, audio characteristics of the person, and facial characteristics of the person. Unless express permission is provided, these characteristics are not associated with any names and are not stored with any personally identifiable information. Rather, for the purposes of this disclosure, any characteristics of a person are merely stored as a generic person having these characteristics, which future characteristics are compared against for determining same or different persons.

Analysis module 222 may compare the one or more characteristics of the person to entries in a database of persons having previously crossed the entry boundary within a predetermined time period. In response to determining that the person is not present in the database of persons having previously crossed the entry boundary within the predetermined time period, analysis module 222 may add the person to the database of persons having previously crossed the entry boundary within the predetermined time period and update the counter based on the person crossing from the first side of the entry boundary to the second side of the entry boundary and based on the determining that the person is not present in the database of persons having previously crossed the entry boundary within the predetermined time period.

In some such instances, the person may be a first person, and, in response to updating the counter based on the first person crossing from the first side of the entry boundary to the second side of the entry boundary and based on the determining that the first person is not present in the database of persons having previously crossed the entry boundary within the predetermined time period, analysis module 222 may update the database to include an indication of the first person and an indication of a presence of the first person on the second side of the entry boundary. In some instances, analysis module 222 may also add the characteristics of the detected person to the database even if the person is present in the database to simply add additional data points recognizing that person based on the characteristics as viewed from that particular angle, camera, or lighting situation. Analysis module 222 may detect that a second person crosses to a first side of an entry boundary in a second video stream from a second camera of the one or more cameras from a second side of the entry boundary. Analysis module 222 may detect one or more characteristics of the second person in the second video stream and determine, based on the one or more characteristics of the second person, that the second person is the first person. In such instances, analysis module 222 may update the counter and update the database to change the entry for the first person to show an indication that the first person is no longer present on the second side of the entry boundary.

In some instances, the entry boundary may be one or more of a line, a line segment (or multiple line segments), or an open arc. In other instances, the entry boundary may be a closed geometric shape, wherein the first side of the entry boundary is an outside of the closed geometric shape, and wherein the second side of the entry boundary in an inside of the closed geometric shape. In some such instances, the closed geometric shape may be surrounding an object, such as a piece of playground equipment.

In some instances, in response to detecting the person crossing from the first side of the entry boundary to the second side of the entry boundary, analysis module 222 may start a timer that remains running as long as the person is within the second side of the entry boundary.

In some instances, analysis module 222 may start a play timer to detect how long the person is physically using the piece of playground equipment.

In some instances, the closed geometric shape of the entry boundary may be a first zone. For one or more other areas in one or more other video streams captured by one or more other cameras of the one or more cameras, analysis module 222 may define a respective entry boundary in the respective area on the respective video stream as a respective closed geometric shape comprising a respective zone. In some such instances, analysis module 222 may further determine an order that the person enters and exits one or more of the first zone and the one or more other zones, where the order includes a first entered zone and a last entered zone. Alternatively or additionally, analysis module 222 may determine a number of times the person enters and exits each of the first zone and the one or more other zones.

In some instances, analysis module 222 may monitor a piece of equipment within the entry boundary in the first video stream. Based on the monitoring of the first video stream, analysis module 222 may determine that the piece of equipment requires maintenance.

In some instances, analysis module 222 may determine that the person entered the entry boundary in the first video stream with a particular object. Analysis module 222 may then determine that the person exited the entry boundary in the first video stream without the particular object. In such instances, Communication module 220 may output a notification to an output device that the person left the particular object in the first area.

In some instances, a plurality of cameras are each pointed at the first area.

In some instance, analysis module 222 may detect initial facial characteristics of the person in the first video stream as they enter the entry boundary. Those facial characteristics may include characteristics such as a color and its temporal variation, a sweat level, and a breathing rate, among other things. Analysis module 222 may detect a change in the facial characteristics of the person in the first video stream as they remain in the entry boundary. As such, analysis module 222 may determine that the person is experiencing a change in heart rate based at least in part on the change in the facial characteristics.

By detecting initial facial characteristics of a person as they enter an entry boundary and monitoring changes in these characteristics to determine a change in heart rate, computing device 210 leverages video analysis to provide real-time health monitoring without the need for physical contact or wearable devices. By analyzing facial characteristics such as color, sweat level, and breathing rate, the system can infer physiological changes, offering a non-invasive way to monitor a person's health status. This approach is particularly useful in environments where traditional health monitoring methods are impractical, such as crowded venues or public spaces. The integration of this capability into a camera-based monitoring system enhances the utility of existing surveillance infrastructure, providing additional safety and health insights without requiring significant additional hardware. This method can be applied in various scenarios, such as detecting individuals in distress or monitoring the well-being of participants in physically demanding activities.

In some instances, while the person is stationary in a particular spot within the first area at a first time, analysis module 222 may determine one or more physical characteristics of the person and one or more baseline activity characteristics of the person. The one or more physical characteristics may include one or more of a height of the person, a weight of the person, a guessed gender of the person, a race of the person, and an age of the person. Analysis module 222 may track activity of the person within the entry boundary. While the person is stationary in the particular spot within the first area at a second time after the first time, analysis module 222 may determine one or more updated activity characteristics of the person. The activity characteristics (both baseline and updated) may include one or more of a heart rate of the person, a breathing rate of the person, a motion speed of the person, and a sweat level of the person. Based on the one or more physical characteristics of the person, the one or more baseline activity characteristics of the person, the activity of the person, and the one or more updated activity characteristics of the person, analysis module 222 may determine a caloric burn of the person.

By determining physical and baseline activity characteristics of a person while they are stationary within a defined area, tracking their activity, and subsequently determining updated activity characteristics, computing device 210 may calculate the person's caloric burn based on these characteristics and activities. This method provides a practical application in monitoring and analyzing individual health metrics in real-time, offering a non-invasive way to assess physical exertion and energy expenditure. By leveraging video streams and computational analysis, the system can provide insights into personal fitness and health without the need for wearable devices, thus enhancing user convenience and accessibility. This approach can be particularly useful in environments like gyms or rehabilitation centers, where understanding a person's physical activity and caloric burn is important for tailoring fitness programs or monitoring recovery progress.

In some instances, analysis module 222 may determine one or more characteristics of apparel worn by the person. In response to determining that the apparel worn by the person comprises an employee uniform to be worn by an employee of the first area, analysis module 222 may activate facial recognition for only the person to identify the person within an employee database.

In some instances, after receiving explicit approval from the person to perform facial recognition techniques on the person, analysis module 222 may perform the facial recognition techniques on the person within the first video stream. Analysis module 222 may identify the person as an approved person to access a locked restricted area. In response to identifying the person as the approved person to access the locked restricted area, communication module 220 may unlock a lock associated with the locked restricted area such that the person can access the locked restricted area. It is noted that this particular technique may not be performed on general members of the public. Rather, this particular implementation may be performed on employees of a facility who have given express permission for computing device 210 to perform the necessary facial recognition operations on themselves in order to satisfy the necessary laws and regulations.

In some instances, analysis module 222 may detect, based on the first video stream, undesirable activity in the first area, such as a presence of a pet in a no-animal area, a presence of a firearm, a presence of a non-firearm weapon, a fight between two or more people, an unusual circumstance in the area, and a person in need of medical attention. In addition to video analysis, audio analysis could be part of this analysis performed by analysis module 222. For instance, analysis module 222 may utilize audio recognition techniques to recognize animal sounds, gunshots, loud noises and screams indicative of fights, a person yelling for help, or any other noise that may be indicative of such an undesirable activity. In such instances, communication module 220 may output, to an output device, a notification of the undesirable activity.

In some instances, communication module 220 may output, on a display device, a graphical user interface that includes a graphical presentation of the counter. The graphical presentation of the counter may include one or more of a textual indication of the counter, a graph representation of the counter over an hour, a graph representation of the counter over an event, a graph representation of the counter over a day, a graph representation of the counter over a week, a graph representation of the counter over a month, and a graph representation of the counter over a year (or any other custom time period).

In some instances, analysis module 222 may compare the counter to a population capacity. In response to the counter meeting or exceeding the population capacity, communication module 220 may output, to an output device, a notification that a venue has reached maximum capacity.

In some instances, for a second area in a second video stream captured by a second camera of the one or more cameras, the second area being different than the first area, wherein a venue comprises the first area and the second area, analysis module 222 may define an entry boundary in the second area on the second video stream. The first and second areas may be completely separate areas or may have overlapping portions that are covered by both the first and second cameras. Analysis module 222 may detect, within the second video stream, a second person crossing from a first side of the entry boundary in the second area to a second side of the entry boundary in the second area. Analysis module 222 may update the counter based on the person crossing from the first side of the entry boundary in the second area to the second side of the entry boundary in the second area, wherein the counter represents a total number of people present in the venue.

In some instances, communication module 220 may receive a request to add a second camera to the one or more cameras. Communication module 220 may receive one or more images that includes the respective area. The one or more images may include an aerial image, such as from a drone or some other highly elevated computing device or camera. Analysis module 222 may map each of the one or more cameras to portions in the one or more images covered by other cameras of the one or more cameras. Analysis module 222 may determine that a particular sector in the one or more images is not covered by any of the one or more cameras. Analysis module 222 may generate a graphical user interface that includes at least a first image of the one or more images and a graphical indication of the particular sector not covered by any of the one or more cameras. Communication module 220 may output, to a display device, the graphical user interface.

Utilizing these techniques to add a second camera to the system may enhance the adaptability and coverage of a camera system used for monitoring a venue. By receiving a request to add a second camera, the system can dynamically adjust to changes in the monitored environment. The method includes receiving images of the area, mapping each camera to portions of these images, and identifying sectors not covered by any cameras. This process allows for the generation of a graphical user interface that visually indicates uncovered sectors, facilitating the strategic placement of additional cameras. This approach ensures comprehensive monitoring by identifying and addressing blind spots, thereby improving the system's ability to track and manage population and activity within the venue. The use of aerial images for mapping enhances the accuracy of camera placement, ensuring optimal coverage and reducing the likelihood of unmonitored areas. This method provides a practical solution for expanding and optimizing surveillance systems in dynamic environments, such as large venues with multiple entry and exit points.

In some such instances, at the time of install, an optimization method such as genetic algorithm or reinforcement learning can be used to optimize number and location of the cameras for a specific objective (area coverage, accuracy, etc.). A 3D scan (e.g., such as with a drone) or a 3D simulation of the field and its content/objects (using software), as well as adding real-world features such as illumination using video game engines, can help the optimization.

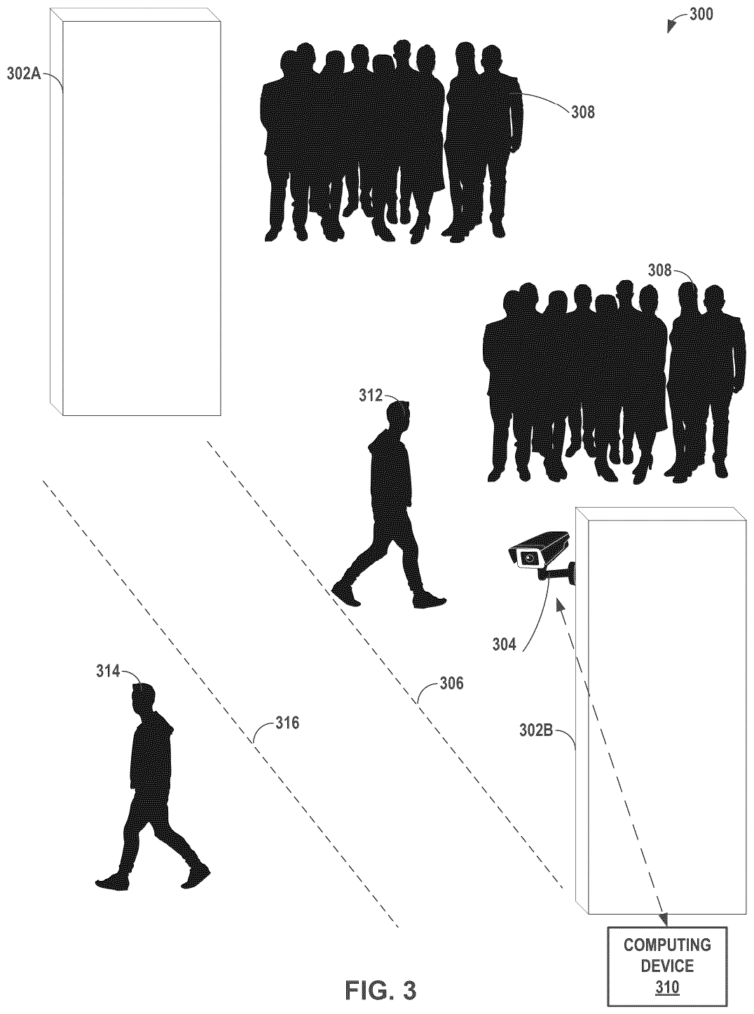

FIG. 3 is a conceptual diagram illustrating a venue with two different boundaries 306 and 316 defined by the camera system 304 on pillar 302B and computing device 310 to monitor population and activity, in accordance with the techniques described herein. In the example of FIG. 3, camera 304 may be similar to and perform similar functions as camera 104 of FIG. 1, and computing device 310 may be similar to and perform similar functions as computing device 110 of FIGS. 1 and 2.

In the example of FIG. 3, computing device 310 may establish two different boundaries in venue 300 to more accurately monitor entries and exits from venue 300. For instance, person 312 may not have counted as an entry into venue 300 when computing device 310 determines that person 312 crosses first, exit boundary 316, but may count person 312 as an entry once they cross entry boundary 306 further inside venue 300. Additionally, computing device may not count person 314 as an exit from venue 300 when they cross the more interior entry boundary 306, but rather counting them as an exit once they cross the more exterior exit boundary 316. By not counting the exit or entry until the person goes further into or out of venue 300 through the creation of a second boundary, a system in accordance with FIG. 3 may be even more accurate in counting populations.

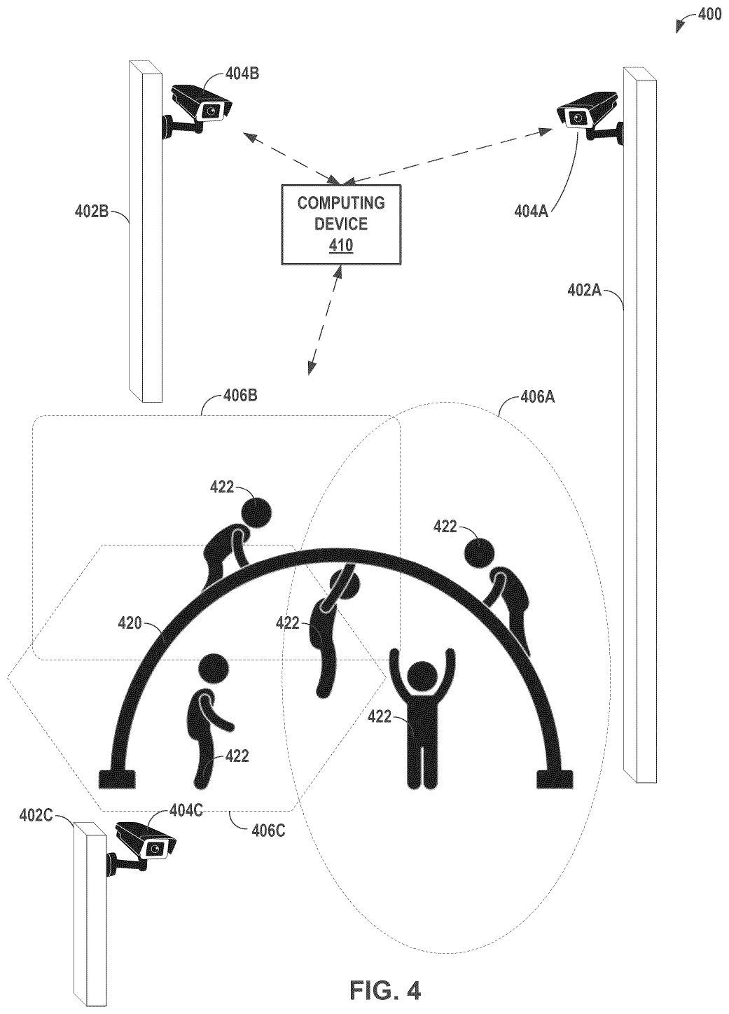

FIG. 4 is a conceptual diagram illustrating a camera system 404A-404C on respective pillars 402A-402C and computing device 410 configured to monitor population and activity on a piece of playground equipment 420, in accordance with the techniques described herein. While FIG. 4 shows camera system 404A-404C monitoring playground equipment 420, in other instances, playground equipment 420 may be any object or area of interest, and camera system 404A-404C and computing device 410 may perform the various techniques described herein in a similar manner. In the example of FIG. 4, cameras 404A-404C may be similar to and perform similar functions as camera 104 of FIG. 1, and computing device 410 may be similar to and perform similar functions as computing device 110 of FIGS. 1 and 2.

In addition to the attendance uses described above, the system described herein may utilize the population and activity monitoring techniques to analyze playground equipment use. For instance, camera systems 404A, 404B, and 404C (collectively, “404A-404C”) may draw respective entry boundaries 406A, 406B, and 406C (collectively, “406A-406C”) around playground equipment 420, which may be a jungle gym, a swing set, a slide, monkey bars, or any other piece of playground equipment. Camera systems 404A-404C may monitor participants 422 and computing device 410 may capture certain characteristics, such as time spent on playground equipment 420, how many times participants return to playground equipment 420, or an order in which participants 422 utilize playground equipment 420 along with other pieces of equipment. This may enable managers to track whether certain equipment is used, how often the equipment is used, and whether certain equipment should be removed in favor of other equipment that may be more popular. Computing device 410 could also use the video stream captured by cameras 404A-404C to determine if playground equipment 420 requires maintenance or replacement of certain parts.

Additionally, this system may enable managers and computing device 410 to track an order of usage of equipment, a distribution of time usage of each equipment for individuals, and footsteps to see which areas of playground are used for maintenance purposes, as well as improving safety, such as by flattening those areas or making sure sharp objects are not there, or even to remove benches/obstacles in high traffic areas.

In the example of FIG. 4, three different cameras 404A, 404B, and 404C capture respective video streams and each transmit the respective video stream to computing device 410. In this manner, the arrangement of cameras 404A-404C may be such that every possible angle of entry into the area of playground equipment 420 is captured by at least one of cameras 404A-404C. In other examples, cameras may be positioned such that only a single camera or only two cameras are needed to capture every possible angle of entry into the area of playground equipment 420, while still other examples may require a greater number of cameras to capture every possible angle of entry into the area of playground equipment 420, or every possible point within the playground that people may pass on, meaning that movement within the playground may also be tracked. Regardless of the number of cameras, computing device 410 may receive video streams from each camera present and analyze the data in such a way that every entry into and exit from the area of playground equipment 420 is counted while eliminating duplicate counts from a single person being captured in multiple cameras using the identification techniques described throughout this disclosure. Additionally, entry boundaries 406A-406C may be in any shape that adequately captures the angle of entry into the area of playground equipment 420, including circular, oval, rectangular, hexagonal, or any other normal or abnormal polygon shape.

Cameras views are mapped to the two-dimensional plane of the playground and there may be overlapping areas when using multiple cameras. Computing device 410 may give priority to a camera that will take over the analysis on overlapping area. This priority can be given by various methods such as manually selecting regions for each camera, calculating object sizes at each point on playground for each camera and enabling the camera that sees the object larger to track that object, calculating distance of each object to cameras that sees it and pick the camera that it is closer to.

Another approach is to use a distance threshold after mapping the people on playground from each camera's view. If people are closer to each other than the distance threshold, they may be perceived as one person and the camera that detects the person with the highest confidence (probability of object detection) may be in charge of tracking the person in that specific spot.

Additionally or alternatively, the mapping may be a three-dimensional mapping. The general the assumption for mapping people to a drone view (or a bird-eye view from the stationary cameras) is that objects are mapped to the playground (ground level). This assumption may not be valid if people are at a different height such as the time they are on a slide or swing or ladder (any equipment that changes the height of people). As a solution, computing device 410 may perform corrections. One instance of such corrections is to calibrate all of the cameras to find their intrinsic and extrinsic parameters to find exact positions of each object in the three-dimensional space.

A less computationally heavy method is for computing device 410 to identify locations in the park at which people are at a higher elevation than ground level, such as top of the slides. These areas may be mapped to the two-dimensional view of at least two cameras. Then, whenever computing device 410 detects a person present in these areas of each of the two paired cameras at the same time, computing device 410 may anticipate that the person is at a higher elevation. Computing device 410 can run re-identification processes (e.g., comparing the appearance of the person in the two cameras) to verify they are the same person in the two views. In such instances, computing device 410 can selectively focus on areas of the park that do not follow the “every person is on the ground” assumption and perceive that they are on an equipment at an elevated height.

In the example of FIG. 4, the entry boundary is defined as a closed geometric shape, with the first side being the outside and the second side being the inside of this shape. This configuration allows for precise monitoring of a defined area, such as a specific zone within a venue or around an object. By using a closed geometric shape, the system can accurately determine when a person enters or exits the designated area, reducing false positives that might occur with linear or open boundaries. This setup is particularly useful in environments where monitoring access to specific areas is important, such as restricted zones or areas with limited capacity. The closed geometric shape ensures that only those who fully cross into the defined area are counted, enhancing the accuracy of population tracking and activity monitoring. This method can be applied to various scenarios, such as monitoring entry into a playground area or a secure facility, providing a reliable way to manage and control access.

Throughout the disclosure, examples are described where a computing device and/or a computing system may analyze information (e.g., people's physical characteristics etc.) only if the system receives permission from the person to analyze the information and only in compliance with applicable local, state, and federal privacy laws. For example, in situations discussed below in which the computing device may collect or may make use of information associated with the person, the person may be provided with an opportunity to provide input to control whether programs or features of the computing device can collect and make use of user information (e.g., their physical characteristics etc.), or to dictate whether and/or how the computing device may receive content that may be relevant to the person. In addition, certain data may be treated in one or more ways before it is stored or used by the computing device and/or computing system, so that personally identifiable information is removed, such as names, home addresses, work addresses, or any other information from which a person's identity could be accurately determined. For example, a person's identity may be treated so that no personally-identifiable information can be determined about the user, or a user's geographic location may be generalized where location information is obtained (such as to a city, ZIP code, or state level), so that a particular location of a user cannot be determined. Thus, the person may have control over how information is collected about the person and used by the computing device. Furthermore, the techniques of this disclosure are only to be used in manners and methods that strictly follow all local, state, and federal laws at the time of use, and are not to be used in violation of such laws. For instance, any and all data collection and processing techniques used for the techniques described herein may only utilize portions of the data that the systems are legally permitted to consume for the purposes of performing the techniques described herein. In other instances where physical characteristics are not used, the computing device and systems described herein may only analyze the presence of a person and not attempt to identify the person within the captured video streams.

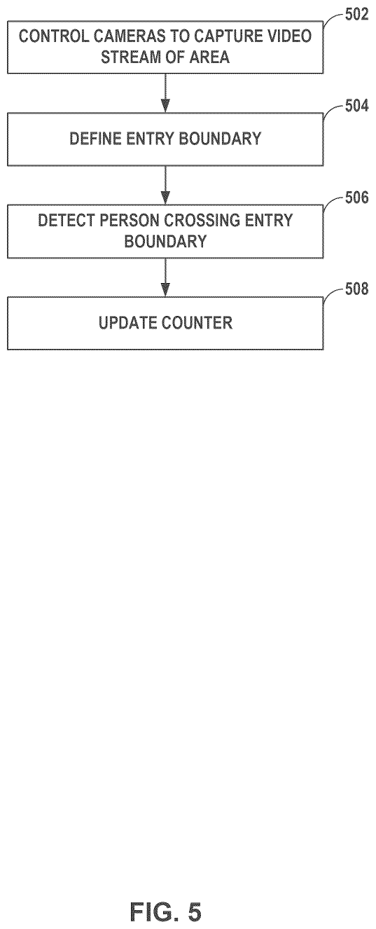

FIG. 5 is a flow diagram illustrating an example method for monitoring population and activity at a venue, in accordance with the techniques described herein. The techniques of FIG. 5 may be performed by one or more processors of a computing device, such as system 100 of FIG. 1 and/or computing device 210 illustrated in FIG. 2. For purposes of illustration only, the techniques of FIG. 5 are described within the context of computing device 210 of FIG. 2, although computing devices having configurations different than that of computing device 210 may perform the techniques of FIG. 5.

In accordance with the techniques of this disclosure, communication module 220 controls each of one or more cameras (e.g., camera 104) to capture a respective video stream of a respective area (502). For a first area in a first video stream captured by a first camera of the one or more cameras, analysis module 222 defines an entry boundary in the first area on the first video stream (504). Analysis module 222 detects, within the first video stream, a person crossing from a first side of the entry boundary to a second side of the entry boundary (506). Analysis module 222 updates a counter based on the person crossing from the first side of the entry boundary to the second side of the entry boundary (508).

FIG. 5 describes a method involving the use of one or more processors to control cameras for capturing video streams of specific areas, defining entry boundaries within these streams, detecting individuals crossing these boundaries, and updating a counter based on these crossings. This method provides a systematic approach to monitoring and managing population flow within a venue. By automating the detection of individuals crossing predefined boundaries, the system can accurately track the number of people entering or exiting a specific area without the need for manual counting or ticketing systems. This is particularly advantageous in venues with multiple entry and exit points, where traditional methods may be impractical or inaccurate. The use of video streams and automated detection reduces human error and enhances the reliability of population monitoring, ensuring compliance with safety regulations and optimizing resource allocation. Additionally, the real-time updating of counters allows for immediate response to changes in population density, which can be important for maintaining safety and operational efficiency in crowded environments.

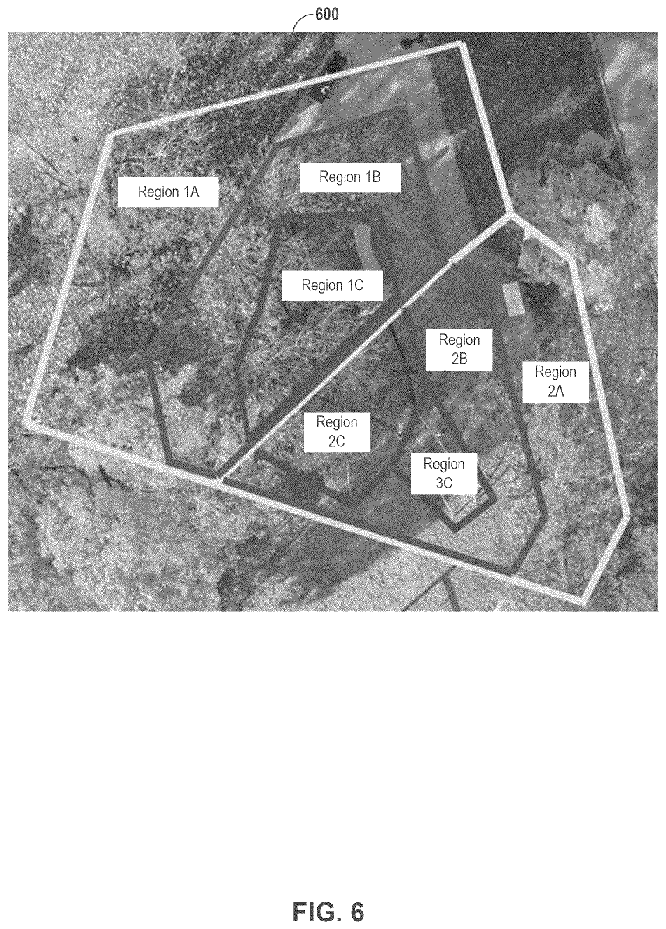

FIG. 6 is an image 600 illustrating an aerial view of an area of interest monitored by multiple cameras, in accordance with the techniques described herein. In the example of FIG. 6, there is an outer boundary (regions 1A and 2A) around a park/playground to separate the people that the system wishes to count and those that the system does not want to count. As soon as people enter the outer regions 1A or 2A, the system may begin tracking that person.

The next level of boundary is the middle boundary which is a closed boundary including regions 1B and 2B on what is defined as the playground in image 600. Whoever passes from the outer regions 1A and 2A into middle regions 1B and 2B, or vice versa, has entered/exited the park.

The level of boundary is the inner boundary, which is an equipment region defined by regions 1C, 2C, and 3C, which is drawn to distinguish a region around defined equipment and if a person who is in the middle region 1B/2B enters that region 1C/2C/3C, the system may consider that person to use the equipment. For example, in the attached picture, region 3C shows the ladder for a piece of equipment.

In some examples, not every point within these areas can be seen by every camera. For FIG. 6, region 1A of the outer boundary, region 1B of middle boundary, and region 1C of the inner boundary may be watched by camera 1 (not pictured), while region 2A of the outer boundary, region 2B of the middle boundary, and regions 2C and 3C of the inner boundary may be watched with camera 2 (not pictured).

In the example of FIG. 6, the entry boundary is defined as a closed geometric shape, with the first side being the outside and the second side being the inside of this shape. This configuration allows for precise monitoring of a defined area, such as a specific zone within a venue or around an object. By using a closed geometric shape, the system can accurately determine when a person enters or exits the designated area, reducing false positives that might occur with linear or open boundaries. This setup is particularly useful in environments where monitoring access to specific areas is important, such as restricted zones or areas with limited capacity. The closed geometric shape ensures that only those who fully cross into the defined area are counted, enhancing the accuracy of population tracking and activity monitoring. This method can be applied to various scenarios, such as monitoring entry into a playground area or a secure facility, providing a reliable way to manage and control access.

Example 1. A method comprising: controlling, by one or more processors, each of one or more cameras to capture a respective video stream of a respective area; and for a first area in a first video stream captured by a first camera of the one or more cameras: defining, by the one or more processors, an entry boundary in the first area on the first video stream; detecting, by the one or more processors and within the first video stream, a person crossing from a first side of the entry boundary to a second side of the entry boundary; and updating, by the one or more processors, a counter based on the person crossing from the first side of the entry boundary to the second side of the entry boundary.

Example 2. The method of example 1, further comprising: defining, by the one or more processors, an exit area as being on the first side of the entry boundary; defining, by the one or more processors, an entry area as being on the second side of the entry boundary; and updating, by the one or more processors, increasing the counter based on the person crossing from the exit area to the entry area.

Example 3. The method of example 1, further comprising: defining, by the one or more processors, an entry area as being on the first side of the entry boundary; defining, by the one or more processors, an exit area as being on the second side of the entry boundary; and updating, by the one or more processors, decreasing the counter based on the person crossing from the exit area to the entry area.

Example 4. The method of example 1, further comprising: defining, by the one or more processors, an exit boundary in the first area on the first video stream; and detecting, by the one or more processors and within the first video stream, the person crossing from a first side of the exit boundary to a second side of the exit boundary.

Example 5. The method of example 4, wherein the counter comprises a current population counter, and wherein the method further comprises: updating, by the one or more processors, the counter based on the person crossing from the first side of the exit boundary to the second side of the exit boundary.

Example 6. The method of example 4, wherein the counter comprises a total population counter, and wherein the method further comprises: refraining from updating, by the one or more processors, the counter based on the person crossing from the first side of the exit boundary to the second side of the exit boundary.

Example 7. The method of any one or more of examples 4-6, wherein the exit boundary comprises a same boundary as the entry boundary.

Example 8. The method of any one or more of examples 4-6, wherein the exit boundary is distinct from the entry boundary, wherein the exit boundary is on the first side of the entry boundary, and wherein the entry boundary is on the first side of the exit boundary.

Example 9. The method of any one or more of examples 1-8, further comprising: determining, by the one or more processors, one or more characteristics of the person; comparing, by the one or more processors, the one or more characteristics of the person to entries in a database of persons having previously crossed the entry boundary within a predetermined time period; and in response to determining that the person is not present in the database of persons having previously crossed the entry boundary within the predetermined time period: adding, the by one or more processors, the person to the database of persons having previously crossed the entry boundary within the predetermined time period; and updating, by the one or more processors, the counter based on the person crossing from the first side of the entry boundary to the second side of the entry boundary and based on the determining that the person is not present in the database of persons having previously crossed the entry boundary within the predetermined time period.

Example 10. The method of example 9, wherein the one or more characteristics of the person include one or more of: apparel worn by the person; hair color of the person; hair length of the person; height of the person; weight of the person; audio characteristics of the person; motion characteristics of the person; and facial characteristics of the person.

Example 11. The method of any one or more of examples 9-10, wherein the person comprises a first person, and wherein the method further comprises: in response to updating the counter based on the first person crossing from the first side of the entry boundary to the second side of the entry boundary and based on the determining that the first person is not present in the database of persons having previously crossed the entry boundary within the predetermined time period, updating, by the one or more processors, the database to include an indication of the first person and an indication of a presence of the first person on the second side of the entry boundary; detecting, by the one or more processors, that a second person crosses to a first side of an entry boundary in a second video stream from a second camera of the one or more cameras from a second side of the entry boundary; detecting, by the one or more processors, one or more characteristics of the second person in the second video stream; determining, by the one or more processors and based on the one or more characteristics of the second person, that the second person is the first person; updating, by the one or more processors, the counter; and updating, by the one or more processors, the database to change the entry for the first person to show an indication that the first person is no longer present on the second side of the entry boundary.

Example 12. The method of any one or more of examples 1-11, wherein the entry boundary comprises one or more of a line, a line segment, or an open arc.

Example 13. The method of any one or more of examples 1-11, wherein the entry boundary comprises a closed geometric shape, wherein the first side of the entry boundary comprises an outside of the closed geometric shape, and wherein the second side of the entry boundary comprises an inside of the closed geometric shape.

Example 14. The method of example 13, wherein the closed geometric shape is surrounding an object.

Example 15. The method of example 14, wherein the object comprises a piece of playground equipment.

Example 16. The method of any one or more of examples 13-15, further comprising: in response to detecting the person crossing from the first side of the entry boundary to the second side of the entry boundary, starting, by the one or more processors, a timer that remains running as long as the person is within the second side of the entry boundary.

Example 17. The method of any one or more of examples 15-16, further comprising:
starting, by the one or more processors, a play timer to detect how long the person is physically using the piece of playground equipment.

Example 18. The method of any one or more of examples 13-17, wherein the closed geometric shape of the entry boundary comprises a first zone, further comprising: for one or more other areas in one or more other video streams captured by one or more other cameras of the one or more cameras: defining, by the one or more processors, a respective entry boundary in the respective area on the respective video stream as a respective closed geometric shape comprising a respective zone.

Example 19. The method of example 18, further comprising: determining, by the one or more processors, an order that the person enters and exits one or more of the first zone and the one or more other zones.

Example 20. The method of example 19, wherein the order includes a first entered zone and a last entered zone.

Example 21. The method of any one or more of examples 18-20, further comprising: determining, by the one or more processors, a number of times the person enters and exits each of the first zone and the one or more other zones.

Example 22. The method of any one or more of examples 13-21, further comprising: monitoring, by the one or more processors, a piece of equipment within the entry boundary in the first video stream; and based on the monitoring of the first video stream, determining, by the one or more processors, that the piece of equipment requires maintenance.

Example 23. The method of any one or more of examples 13-22, further comprising: determining, by the one or more processors, that the person entered the entry boundary in the first video stream with a particular object; determining, by the one or more processors, that the person exited the entry boundary in the first video stream without the particular object; and outputting, by the one or more processors, a notification to an output device that the person left the particular object in the first area.

Example 24. The method of any one or more of examples 13-23, wherein a plurality of cameras are each pointed at the first area.

Example 25. The method of any one or more of examples 13-24, further comprising: detecting, by the one or more processors, initial facial characteristics of the person in the first video stream as they enter the entry boundary; detecting, by the one or more processors, a change in the facial characteristics of the person in the first video stream as they remain in the entry boundary; and determining, by the one or more processors, that the person is experiencing a change in heart rate based at least in part on the change in the facial characteristics.

Example 26. The method of example 25, wherein the facial characteristics comprise one or more of: a color; a sweat level; and a breathing rate.

Example 27. The method of any one or more of examples 13-26, further comprising: while the person is stationary in a particular spot within the first area at a first time, determining, by the one or more processors, one or more physical characteristics of the person and one or more baseline activity characteristics of the person; tracking, by the one or more processors, activity of the person within the entry boundary; while the person is stationary in the particular spot within the first area at a second time after the first time, determining, by the one or more processors, one or more updated activity characteristics of the person; and based on the one or more physical characteristics of the person, the one or more baseline activity characteristics of the person, the activity of the person, and the one or more updated activity characteristics of the person, determining, by the one or more processors, a caloric burn of the person.

Example 28. The method of example 27, wherein the one or more physical characteristics of the person comprise one or more of: a height of the person; a weight of the person; a guessed gender of the person; a race of the person; and an age of the person.

Example 29. The method of any one or more of examples 27-28, wherein the one or more baseline activity characteristics of the person and the one or more updated activity characteristics of the person each comprise one or more of: a heart rate of the person; a breathing rate of the person; a motion speed of the person; and a sweat level of the person.

Example 30. The method of any one or more of examples 1-29, further comprising: determining, by the one or more processors, one or more characteristics of apparel worn by the person; in response to determining that the apparel worn by the person comprises an employee uniform to be worn by an employee of the first area, activating, by the one or more processors, facial recognition for only the person to identify the person within an employee database.

Example 31. The method of any one or more of examples 1-30, further comprising: after receiving explicit approval from the person to perform facial recognition techniques on the person, performing, by the one or more processors, the facial recognition techniques on the person within the first video stream; identifying, by the one or more processors, the person as an approved person to access a locked restricted area; and in response to identifying the person as the approved person to access the locked restricted area, unlocking, by the one or more processors, a lock associated with the locked restricted area such that the person can access the locked restricted area.

Example 32. The method of any one or more of examples 1-31, further comprising: detecting, by the one or more processors and based on the first video stream, undesirable activity in the first area; and outputting, by the one or more processors and to an output device, a notification of the undesirable activity.

Example 33. The method of example 32, wherein the undesirable activity comprises one or more of: a presence of a pet in a no-animal area; a presence of a firearm; a presence of a non-firearm weapon; a fight between two or more people; an unusual circumstance in the area; and a person in need of medical attention.

Example 34. The method of any one or more of examples 1-33, further comprising: outputting, by the one or more processors and on a display device, a graphical user interface that includes a graphical presentation of the counter.

Example 35. The method of example 34, wherein the graphical presentation of the counter comprises one or more of: a textual indication of the counter; a graph representation of the counter over an hour; a graph representation of the counter over an event; a graph representation of the counter over a day; a graph representation of the counter over a week; a graph representation of the counter over a month; and a graph representation of the counter over a year.

Example 36. The method of any one or more of examples 1-35, further comprising: comparing, by the one or more processors, the counter to a population capacity; and in response to the counter meeting or exceeding the population capacity, outputting, by the one or more processors and to an output device, a notification that a venue has reached maximum capacity.

Example 37. The method of any one or more of examples 1-36, further comprising: for a second area in a second video stream captured by a second camera of the one or more cameras, the second area being different than the first area, wherein a venue comprises the first area and the second area: defining, by the one or more processors, an entry boundary in the second area on the second video stream; detecting, by the one or more processors and within the second video stream, a second person crossing from a first side of the entry boundary in the second area to a second side of the entry boundary in the second area; and updating, by the one or more processors, the counter based on the person crossing from the first side of the entry boundary in the second area to the second side of the entry boundary in the second area, wherein the counter represents a total number of people present in the venue.

Example 38. The method of any one or more of examples 1-37, further comprising: receiving, by the one or more processors, a request to add a second camera to the one or more cameras; receiving, by the one or more processors, one or more images that includes the respective area; mapping, by the one or more processors, each of the one or more cameras to portions in the one or more images covered by other cameras of the one or more cameras; determining, by the one or more processors, that a particular sector in the one or more images is not covered by any of the one or more cameras; generating, by the one or more processors, a graphical user interface that includes at least a first image of the one or more images and a graphical indication of the particular sector not covered by any of the one or more cameras; and outputting, by the one or more processors and to a display device, the graphical user interface.

Example 39. The method of example 38, wherein the one or more images comprise an aerial image.

Example 40. A method for performing any of the techniques of any combination of examples 1-39.

Example 41. A device configured to perform any of the methods of any combination of examples 1-39.

Example 42. An apparatus comprising means for performing any of the method of any combination of examples 1-39.

Example 43. A non-transitory computer-readable storage medium having stored thereon instructions that, when executed, cause one or more processors of a computing device to perform the method of any combination of examples 1-39.

Example 44. A system comprising one or more computing devices configured to perform a method of any combination of examples 1-39.

Example 45. Any of the techniques described herein.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1. A method comprising:
controlling, by one or more processors, each of one or more cameras to capture a respective video stream of a respective area; and
for a first area in a first video stream captured by a first camera of the one or more cameras:
defining, by the one or more processors, an entry boundary in the first area on the first video stream;
detecting, by the one or more processors and within the first video stream, a person crossing from a first side of the entry boundary to a second side of the entry boundary; and
updating, by the one or more processors, a counter based on the person crossing from the first side of the entry boundary to the second side of the entry boundary.

2. The method of claim 1, further comprising:
defining, by the one or more processors, an exit area as being on the first side of the entry boundary;
defining, by the one or more processors, an entry area as being on the second side of the entry boundary; and
updating, by the one or more processors, the counter by increasing the counter based on the person crossing from the exit area to the entry area.

3. The method of claim 1, further comprising:
defining, by the one or more processors, an entry area as being on the first side of the entry boundary;
defining, by the one or more processors, an exit area as being on the second side of the entry boundary; and
updating, by the one or more processors, the counter by decreasing the counter based on the person crossing from the exit area to the entry area.

4. The method of claim 1, further comprising:
defining, by the one or more processors, an exit boundary in the first area on the first video stream; and
detecting, by the one or more processors and within the first video stream, the person crossing from a first side of the exit boundary to a second side of the exit boundary.

5. The method of claim 4, wherein the counter comprises a current population counter, and wherein the method further comprises:
updating, by the one or more processors, the counter based on the person crossing from the first side of the exit boundary to the second side of the exit boundary.

6. The method of claim 4, wherein the counter comprises a total population counter, and wherein the method further comprises:
refraining from updating, by the one or more processors, the counter based on the person crossing from the first side of the exit boundary to the second side of the exit boundary.

7. The method of claim 4, wherein the exit boundary comprises a same boundary as the entry boundary.

8. The method of claim 4, wherein the exit boundary is distinct from the entry boundary, wherein the exit boundary is on the first side of the entry boundary, and wherein the entry boundary is on the first side of the exit boundary.

9. The method of claim 1, further comprising:
determining, by the one or more processors, one or more characteristics of the person;
comparing, by the one or more processors, the one or more characteristics of the person to entries in a database of persons having previously crossed the entry boundary within a predetermined time period; and
in response to determining that the person is not present in the database of persons having previously crossed the entry boundary within the predetermined time period:
adding, the by one or more processors, the person to the database of persons having previously crossed the entry boundary within the predetermined time period; and
updating, by the one or more processors, the counter based on the person crossing from the first side of the entry boundary to the second side of the entry boundary and based on the determining that the person is not present in the database of persons having previously crossed the entry boundary within the predetermined time period.

10. The method of claim 9, wherein the one or more characteristics of the person include one or more of:
apparel worn by the person;
hair color of the person;
hair length of the person;
height of the person;
weight of the person;
audio characteristics of the person;
motion characteristics of the person; and
facial characteristics of the person.

11. The method of claim 9, wherein the person comprises a first person, and wherein the method further comprises:
in response to updating the counter based on the first person crossing from the first side of the entry boundary to the second side of the entry boundary and based on the determining that the first person is not present in the database of persons having previously crossed the entry boundary within the predetermined time period, updating, by the one or more processors, the database to include an indication of the first person and an indication of a presence of the first person on the second side of the entry boundary;
detecting, by the one or more processors, that a second person crosses to a first side of an entry boundary in a second video stream from a second camera of the one or more cameras from a second side of the entry boundary;
detecting, by the one or more processors, one or more characteristics of the second person in the second video stream;
determining, by the one or more processors and based on the one or more characteristics of the second person, that the second person is the first person;
updating, by the one or more processors, the counter; and
updating, by the one or more processors, the database to change the entry for the first person to show an indication that the first person is no longer present on the second side of the entry boundary.

12. The method of claim 1, wherein the entry boundary comprises one or more of a line, a line segment, or an open arc.

13. The method of claim 1, wherein the entry boundary comprises a closed geometric shape, wherein the first side of the entry boundary comprises an outside of the closed geometric shape, and wherein the second side of the entry boundary comprises an inside of the closed geometric shape.

14. The method of claim 13, wherein the closed geometric shape is surrounding an object.

15. The method of claim 14, wherein the object comprises a piece of playground equipment.

16. The method of claim 13, further comprising:
in response to detecting the person crossing from the first side of the entry boundary to the second side of the entry boundary, starting, by the one or more processors, a timer that remains running as long as the person is within the second side of the entry boundary.

17. The method of claim 15, further comprising:
starting, by the one or more processors, a play timer to detect how long the person is physically using the piece of playground equipment.

18. The method of claim 13, wherein the closed geometric shape of the entry boundary comprises a first zone, further comprising:
for one or more other areas in one or more other video streams captured by one or more other cameras of the one or more cameras:
defining, by the one or more processors, a respective entry boundary in the respective area on the respective video stream as a respective closed geometric shape comprising a respective zone.

19. The method of claim 18, further comprising:
determining, by the one or more processors, an order that the person enters and exits one or more of the first zone and the one or more other zones.

20. The method of claim 19, wherein the order includes a first entered zone and a last entered zone.

21. The method of claim 18, further comprising:
determining, by the one or more processors, a number of times the person enters and exits each of the first zone and the one or more other zones.

22. The method of claim 13, further comprising:
monitoring, by the one or more processors, a piece of equipment within the entry boundary in the first video stream; and
based on the monitoring of the first video stream, determining, by the one or more processors, that the piece of equipment requires maintenance.

23. The method of claim 13, further comprising:
determining, by the one or more processors, that the person entered the entry boundary in the first video stream with a particular object;
determining, by the one or more processors, that the person exited the entry boundary in the first video stream without the particular object; and
outputting, by the one or more processors, a notification to an output device that the person left the particular object in the first area.

24. The method of claim 13, wherein a plurality of cameras are each pointed at the first area.

25. The method of claim 13, further comprising:
detecting, by the one or more processors, initial facial characteristics of the person in the first video stream as they enter the entry boundary;
detecting, by the one or more processors, a change in the facial characteristics of the person in the first video stream as they remain in the entry boundary; and
determining, by the one or more processors, that the person is experiencing a change in heart rate based at least in part on the change in the facial characteristics.

26. The method of claim 25, wherein the facial characteristics comprise one or more of:
a color;
a sweat level; and
a breathing rate.

27. The method of claim 13, further comprising:
while the person is stationary in a particular spot within the first area at a first time, determining, by the one or more processors, one or more physical characteristics of the person and one or more baseline activity characteristics of the person;
tracking, by the one or more processors, activity of the person within the entry boundary;
while the person is stationary in the particular spot within the first area at a second time after the first time, determining, by the one or more processors, one or more updated activity characteristics of the person; and
based on the one or more physical characteristics of the person, the one or more baseline activity characteristics of the person, the activity of the person, and the one or more updated activity characteristics of the person, determining, by the one or more processors, a caloric burn of the person.

28. The method of claim 27, wherein the one or more physical characteristics of the person comprise one or more of:
a height of the person;
a weight of the person;
a guessed gender of the person;
a race of the person; and
an age of the person.

29. The method of claim 27, wherein the one or more baseline activity characteristics of the person and the one or more updated activity characteristics of the person each comprise one or more of:
a heart rate of the person;
a breathing rate of the person;
a motion speed of the person; and
a sweat level of the person.

30. The method of claim 1, further comprising:
determining, by the one or more processors, one or more characteristics of apparel worn by the person;
in response to determining that the apparel worn by the person comprises an employee uniform to be worn by an employee of the first area, activating, by the one or more processors, facial recognition for only the person to identify the person within an employee database.

31. The method of claim 1, further comprising:
after receiving explicit approval from the person to perform facial recognition techniques on the person, performing, by the one or more processors, the facial recognition techniques on the person within the first video stream;
identifying, by the one or more processors, the person as an approved person to access a locked restricted area; and
in response to identifying the person as the approved person to access the locked restricted area, unlocking, by the one or more processors, a lock associated with the locked restricted area such that the person can access the locked restricted area.

32. The method of claim 1, further comprising:
detecting, by the one or more processors and based on the first video stream, undesirable activity in the first area; and
outputting, by the one or more processors and to an output device, a notification of the undesirable activity.

33. The method of claim 32, wherein the undesirable activity comprises one or more of:
a presence of a pet in a no-animal area;
a presence of a firearm;
a presence of a non-firearm weapon;
a fight between two or more people;
an unusual circumstance in the area; and
a person in need of medical attention.

34. The method of claim 1, further comprising:
outputting, by the one or more processors and on a display device, a graphical user interface that includes a graphical presentation of the counter.

35. The method of claim 34, wherein the graphical presentation of the counter comprises one or more of:
a textual indication of the counter;
a graph representation of the counter over an hour;
a graph representation of the counter over an event;
a graph representation of the counter over a day;
a graph representation of the counter over a week;
a graph representation of the counter over a month; and
a graph representation of the counter over a year.

36. The method of claim 1, further comprising:
comparing, by the one or more processors, the counter to a population capacity; and
in response to the counter meeting or exceeding the population capacity, outputting, by the one or more processors and to an output device, a notification that a venue has reached maximum capacity.

37. The method of claim 1, further comprising:
for a second area in a second video stream captured by a second camera of the one or more cameras, the second area being different than the first area, wherein a venue comprises the first area and the second area:
defining, by the one or more processors, an entry boundary in the second area on the second video stream;
detecting, by the one or more processors and within the second video stream, a second person crossing from a first side of the entry boundary in the second area to a second side of the entry boundary in the second area; and
updating, by the one or more processors, the counter based on the person crossing from the first side of the entry boundary in the second area to the second side of the entry boundary in the second area,
wherein the counter represents a total number of people present in the venue.

38. The method of claim 1, further comprising:
receiving, by the one or more processors, a request to add a second camera to the one or more cameras;
receiving, by the one or more processors, one or more images that includes the respective area;
mapping, by the one or more processors, each of the one or more cameras to portions in the one or more images covered by other cameras of the one or more cameras;
determining, by the one or more processors, that a particular sector in the one or more images is not covered by any of the one or more cameras;
generating, by the one or more processors, a graphical user interface that includes at least a first image of the one or more images and a graphical indication of the particular sector not covered by any of the one or more cameras; and
outputting, by the one or more processors and to a display device, the graphical user interface.

39. The method of claim 38, wherein the one or more images comprise an aerial image.

40. A system comprising:
one or more cameras; and
one or more processors configured to:
control each of the one or more cameras to capture a respective video stream of a respective area; and
for a first area in a first video stream captured by a first camera of the one or more cameras:
define an entry boundary in the first area on the first video stream;
detect, within the first video stream, a person crossing from a first side of the entry boundary to a second side of the entry boundary; and
update a counter based on the person crossing from the first side of the entry boundary to the second side of the entry boundary.

41. A non-transitory computer-readable storage medium having stored thereon instructions that, when executed, cause one or more processors of a computing device to:
control each of one or more cameras to capture a respective video stream of a respective area; and
for a first area in a first video stream captured by a first camera of the one or more cameras:
define an entry boundary in the first area on the first video stream;
detect, within the first video stream, a person crossing from a first side of the entry boundary to a second side of the entry boundary; and
update a counter based on the person crossing from the first side of the entry boundary to the second side of the entry boundary.
